(19) United States
(12) Patent Application Publication
(10) Pub. No.: US 2006/0176638 A1
(43) Pub. Date: Aug. 10, 2006

(54) Minimized wire bonds in transient blocking unit packaging

(75) Inventor: Stephen Coates, San Francisco, CA (US)

Correspondence Address: LUMEN INTELLECTUAL PROPERTY SERVICES, INC., 2345 YALE STREET, 2ND FLOOR, PALO ALTO, CA, 94306, US

(73) Assignee: Fultec Semiconductors, Inc.

(21) Appl. No.: 11/249,165

(22) Filed: Oct. 12, 2005

Related U.S. Application Data
(63) Continuation of application No. 60/651,914, filed on Feb. 10, 2005.

(51) Int. Cl. H02H 9/06

(52) U.S. Cl. 361/118

(57) ABSTRACT

A transient blocking unit (TBU) module which includes a control circuit, for detecting overcurrents, packaged together with integrated over-current protection and discrete over-voltage protection integrated into a single package. In one example embodiment, the present innovations are embodied as a unit for protecting a circuit from high voltage and high current, comprising a transient blocking unit component with at least one high voltage device wherein the transient blocking unit is integrated with the high voltage device.

### CROSS-REFERENCE TO OTHER APPLICATIONS

This application claims priority from U.S. provisional application 60/651,914 filed Feb. 10, 2005, which is hereby incorporated by reference.

### BACKGROUND AND SUMMARY OF THE INVENTION

The present invention relates to integrated surge protecting circuits, and more specifically, to packaged units which include both a surge protecting control die and power devices, and still more specifically to transient blocking modules suitable for telecommunications and power applications.

One of the basic design requirements of a robust electrical system is protection against out-of-specification electrical conditions of many kinds, which can arise from many causes. These may include power surges, transient overcurrents, and voltage spikes corresponding to various values of transient energy and source impedance. Often series-connected devices (such as fuses) are used to protect against overcurrents, while shunt-connected devices (such as thyristors or varistors) are used to drop overvoltages.

A new type of protection component is the transient blocking unit (TBU). The basic TBU is a blocking component rather than a shunting component, so the TBU itself does not have to absorb the full energy of a transient. The TBU is a very fast disconnection device, which can be used as a series protection device to block transient overcurrents and overvoltages, and which returns to normal operation once the transient is gone. (TBUs are typically fast enough to block overvoltages from lightning strikes.) A TBU will typically have a much faster response time than a positive-temperature-coefficient resistor (“PTC”), and does not add significant power dissipation nor require a power source. In addition, the TBU, unlike the PTC, does not limit circuit bandwidth. TBUs are described e.g. in U.S. Pat. No. 5,742,463, in U.S. published application U.S. 2005128669, and in published PCT applications WO2005020402, WO2004034544, WO03069753, and WO2004006408; all of these are hereby incorporated by reference. More explanation of the basic principles of TBUs can be found in a white paper by Richard Harris entitled “Introduction to TBU Protection” (June 2005), which is available at http://www.fultec.com/pdfs/Fultec TBU Introduction.pdf, and which (although not prior art) is hereby incorporated by reference.

Typically a TBU will be manufactured using a semiconductor technology of the “smart power” type, and monolithic TBUs can provide voltage withstand ratings of 1000V or more. However, another class of TBUs combines power devices with a TBU core module, for greater current- and/or voltage-blocking capability. Such integrated TBUs are described, for example, in U.S. patent application Ser. No. 11/130,829 (FUL-017), which is hereby incorporated by reference. The use of discrete power devices permits voltage and impedance characteristics of the switching technology to be perfectly optimized, while incidentally providing perfect isolation. This approach also permits the TBU core module to be built in a more compact or economical semiconductor technology if desired.

Minimized Wire Bonds in Transient Blocking Unit Packaging

Single-chip TBUs have been packaged using conventional leadframe-plus-wirebonding methods. However, the present application teaches that a different packaging approach is advantageous for an integrated TBU module.

One teaching is that, in an integrated TBU module (which includes a TBU control die and one or more switching devices), the active control circuitry preferably does not have any connection to the external terminals. The back surface of the control die will typically have external thermal and ground connections, but the active control circuitry on the front surface of the control die is only connected to the switching devices.

Another teaching is that wire bonding is preferably not used to connect any of the external terminals. Thus in the complete integrated package the backside current-carrying terminals of the switching devices are directly connected to high-current connections (e.g. to lead frame portions which are each connected to multiple external terminals). This minimizes the portion of the current path which is carried by wire bonds, and hence minimizes the series impedance of the integrated TBU.

The above teachings can be combined synergistically, but can also be followed separately.

Advantages of various embodiments described herein include one or more of the following:
Reduced series impedance, as compared to other integrated TBU configurations;
Easier and cheaper manufacturing;
Easy customization of different combinations of control chip and driver chip(s);
Better matching of the devices in order to improve the symmetry of the circuit, particularly in the bi-directional version;
Reduced chance of overvoltage damage to the control circuitry during system assembly;
Reduced chance of in-service failure if transients appear on internal lines of the system;
TBUs can readily be configured for withstand voltage ratings of multiple kilovolts;
Vertical-current-flow switching devices can be used, for improved on-state impedance; and
Newly available power devices can be readily designed into existing modules.

### BRIEF DESCRIPTION OF THE DRAWING

The disclosed inventions will be described with reference to the accompanying drawings, which show important sample embodiments of the invention and which are incorporated in the specification hereof by reference, wherein:

FIG. 1 shows the physical arrangement of a sample embodiment (under the packaging).

FIG. 2 is a top view which gives a clearer look at the positioning of the dice and their wire bonding, in a sample embodiment.

FIG. 3 is an equivalent circuit diagram of a sample embodiment, showing how the control circuitry on the control die is connected to (in this example) two driver devices.

FIG. 4A shows a sample embodiment of the complete packaged module, and FIG. 4B shows an example of the pin assignments of the complete packaged module. Note that, in this embodiment, this is basically a two-terminal device.

FIG. 5 is a modular diagram, and FIG. 6 a sample circuit diagram, showing possible configurations of the control circuitry on die 110.

### DETAILED DESCRIPTION OF THE PREFERRED EMBODIMENTS

The numerous innovative teachings of the present application will be described with particular reference to the presently preferred embodiment (by way of example, and not of limitation).

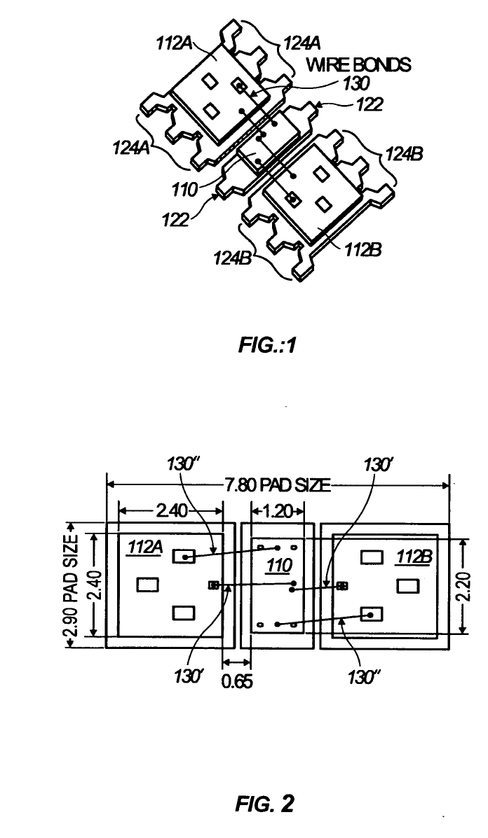

FIG. 1 shows the physical arrangement of a sample embodiment (under the packaging). This sample embodiment is a bidirectional TBU module, which includes three semiconductor dice: two vertical-current-flow NMOS drivers 112, and a TBU “core” control unit 110. (Other configurations and device types can be used, as will be described below.)

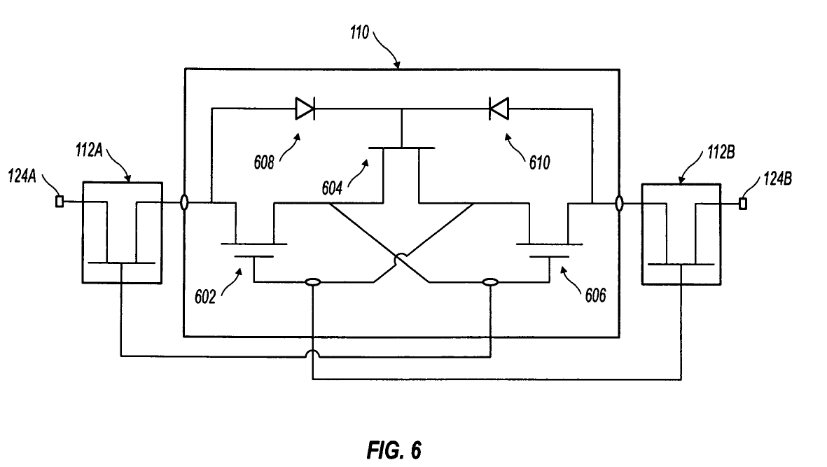

The control die 110 contains TBU control circuitry as described in application Ser. No. 11/130,829 cited above (and hereby again incorporated by reference). (An example of this circuitry can also be seen in FIGS. 5 and 6, described below.) This die is sometimes referred to as the “core” portion of the TBU module. The control die 110 has at least two connections to the frontside of either driver device 112A and 112B. (In the example shown there are two driver devices 112A and 112B, but in other embodiments more or fewer driver devices can be used.) Each driver device 112 has a current-carrying backside connection to a respective leadframe portion 124A/124B.

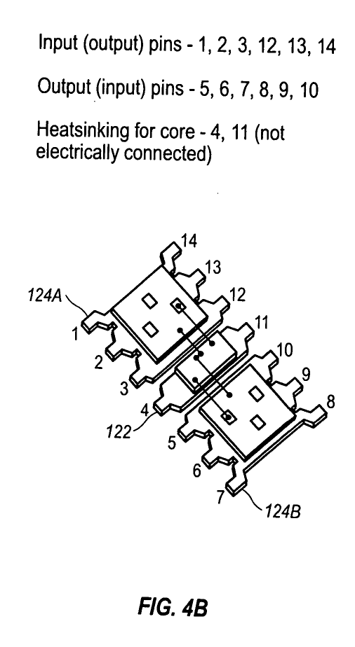

The control circuitry on control die 110 is connected, through wire bonds 130, to the two solid-state driver devices 112. As shown in the circuit diagram of FIG. 3, the control circuitry is connected both to a current-carrying terminal 114 of each of the drivers 112, as well as to a control terminal 113 of each. (In the example shown the drivers are vertical-current-flow NMOS devices, and the control terminals are gate terminals, and the current-carrying terminal 114 to which the control circuitry is connected is a source terminal.)

Referring again to FIG. 1, it can be seen that two wire bonds 130 are shown connecting the core chip 110 to driver device 112A, and two more wire bonds 130 connect the core chip 110 to driver device 112B. (The wire bonds to the current-carrying terminals preferably have low impedance, so multiple strands may be used for the connections.) Note that the lead frame portion 124A is a single continuous piece in this embodiment, i.e. device 112A sees (electrically) only a single external connection, even though six pins of the package are connected to this one terminal. Similarly the backside of driver device 112B is connected (e.g. by conductive epoxy or by soldering) to a single lead frame piece 124B, which also extends to provide six external pins (all electrically connected together).

Note that no wirebonds directly connect the input or the output of the control circuitry on die 110 to any of the external leads of the package; indeed, NONE of the semiconductor portions are wire-bonded to any part of the lead frame.

The control chip die is bonded to its own lead frame portion 122, but preferably this is used merely to provide a thermal path for heat generated in the control die.

The module shown in FIG. 1 is preferably bidirectionally symmetric, so there is no real distinction between the Input and Output sides of the module itself in this particular embodiment (although of course the complete system configuration might imply such identification).

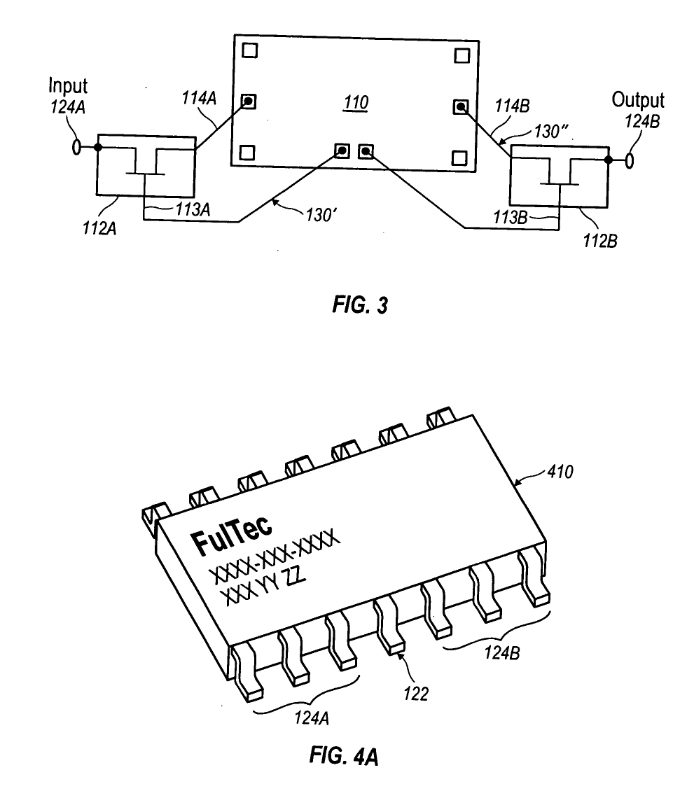

FIG. 2 is a top view which gives a clearer look at the positioning of the dice and their wire bonding, in a sample embodiment. Sample die dimensions are given for better understanding of aspect ratios, but of course these die dimensions are purely exemplary, and would be expected to change over time.

FIG. 2 also shows that the bond wires can be implemented as multiple wires running between a single pair of bond pads. This is particularly attractive for the high-current bond wires 130″, which connect the control die 110 to the frontside current-carrying terminals of the two driver devices. (The bond wires 130′ can also be implemented with multiple wires if desired, but this is less critical.)

FIG. 3 is an equivalent circuit diagram of a sample embodiment, showing how the control circuitry on the control die 110 is connected to (in this example) to two driver devices 112. Note that the driver devices are shown as containing a single FET each, but of course other configurations are possible.

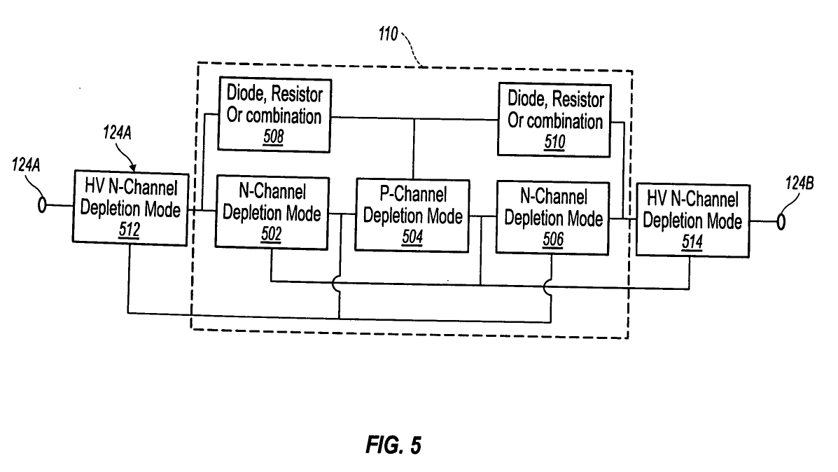

FIG. 4A shows a sample embodiment of the complete packaged module; In this Figure only the external leads 122/124A/124B, of the elements described above, are visible. The encapsulation 410 (epoxy in this case) protects the dice from moisture and dirt.

FIG. 4B shows an example of the pin assignments of the complete packaged module. Note that, in this embodiment, this is basically a two-terminal device.

FIG. 5 shows a sample implementation of the control circuitry in control die 110. In this example implementation, an integrated core TBU is depicted with discrete high voltage devices 512, 514 which are controlled by the core TBU 516.

This example embodiment depicts two n-channel depletion mode devices 502, 504 as the input and output of the integrated core TBU. A p-channel depletion mode device 504 is connected by the gate lead to (in this bi-directional example) two sets of diode, resistor, or some combination thereof 508, 510. This integrated core TBU provides over-current protection. Two n-channel high voltage depletion mode devices 512 (in driver device 112A) and 514 (in driver device 112B) complete the protection circuit by adding over-voltage protection.

Thus, in this example embodiment, the maximum voltage of the TBU circuit is enhanced by adding the high voltage n-channel depletion mode devices at the input (uni- or bi-directional) and output (bi-directional only). The maximum gate voltage applied to the p-channel device is reduced by the blocking action of the high voltage n-channel depletion mode devices 512 and 514.

The breakdown voltage is a function of the maximum pinch-off voltage of the HV input devices. Typical pinch-off of high voltage NJFET or NSIT device is in the 15-20 volt range, and the breakdown voltage of the NMOS device within the core should therefore be in the 35-40 volt range.

The trigger current is the pinch-of voltage of the NMOS device divided by the on resistance of the PJFET device, as described below with respect to FIG. 6.

FIG. 6 shows another sample implementation in which the monolithic core TBU (in control chip 110) is implemented with a PJFET 604 and two NMOS devices 602, 606. This depiction includes high voltage devices 612, 614 are also shown as discrete additions to the integrated core TBU. The PJFET 604 provides the voltage drop necessary to turn off the NMOS devices 602, 606. The maximum voltage requirements are set by the pinch-off voltage of the high voltage (HV) input device or devices.

This results in relaxed requirements for the HV devices. Particularly they no longer require low pinch-off voltage since this function is in the low voltage core TBU circuit. This has the effect of minimizing overall cost and makes for a flexible protection circuit. The core TBU circuit can be used with any high voltage input devices (since the HV devices are not integrated in preferred embodiments). Any type of input/output devices can be used, such as JFET, SIT, or MOSFETs. Further, any material can be used, such as Si or SiC. Finally, the performance of the HV devices is not compromised.

According to various disclosed embodiments there is provided: A transient blocking unit comprising, in a single package having external terminals: one or more driver devices, each connected to control current flow on at least one respective external terminal; and at least one control die which is separate from said driver devices but also contained within said single package, and which contains control circuitry which is connected to respective control terminals of said driver devices, to thereby implement a transient blocking operation, and which is not directly connected to any of said external terminals.

According to various disclosed embodiments there is provided: A unit comprising, in a single package having external terminals: at least one control die containing control circuitry which implements a transient blocking operation; and one or more driver devices, each comprising a backside current-carrying terminal, a frontside current-carrying terminal, and at least one respective control terminal; said frontside current-carrying terminal being connected to said control circuitry, said control terminal also being connected to said control circuitry, and said backside current-carrying terminal being connected to ones of the external terminals; wherein wire bonds connect said driver devices to said control die, but no wire bonds connect said devices nor said die to said external terminals.

According to various disclosed embodiments there is provided: A unit comprising, in a single package having external terminals: one or more vertical-current-flow driver devices, each connected to control current on at least one respective external terminal; and at least one control die which is separate from said driver devices but also contained within said single package, and which contains control circuitry which is connected to detect electrical transients and to activate respective control terminals of said driver devices accordingly to thereby implement a transient blocking operation; wherein wire bonds connect said driver devices to said control circuitry, but no wire bonds connect said devices nor said die to said external terminals.

According to various disclosed embodiments there is provided: A method of blocking electrical transients, comprising the actions of: detecting transients, using a control die which is contained in an integrated module; and selectively blocking currents through external terminals of said device using driver dice which are incorporated in said module with said control die and which are controlled thereby; wherein said control die contains control circuitry which is configured to perform said detection; and wherein said control circuitry is directly connected to said driver dice within said package, but is not otherwise electrically connected to said external terminals.

According to various disclosed embodiments there is provided: A method of blocking electrical transients, comprising the actions of: detecting transients, using a control die which is contained in an integrated module; and selectively blocking currents through external terminals of said device using driver devices which are incorporated in said module with said control die, and are controlled by said control die, but are not part of said control die; wherein said control die is connected to said driver devices by wire bonds, but no wire bonds connect said die nor said devices to said external terminals.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, in various embodiments various package designs can be used, e.g. SoIC or flip chip or (especially) other packages suitable for “smart power” integrated circuits.

Similarly, many changes can optionally be made to the electrical configuration of the TBU components. For example, PMOS can be substituted for NMOS, with appropriate changes in circuit configuration. The driver devices do not have to be pure FET devices, but can be IGBTs or switched-emitter or other hybrid devices.

The driver devices are preferably discrete devices, but (alternatively and less preferably) can themselves include smart-power functionality, and/or can be merged with other functions.

The driver devices do not have to use the same device technology as the core TBU chip, and indeed it can be useful to separately optimize the driver devices without reference to the technology of the core TBU (control chip 110). Thus (for example) SiC or SiGeC driver devices can be combined with SiGe or Si or GaAs control circuitry.

The control die preferably includes TBU control circuits as described in the applications cited above, but alternatively a variety of modifications can be made in the TBU control circuits. For example, the control circuitry can include overtemperature shutdown functions. The exact configuration of the control circuit is not critical, as long as the connection relations described above are maintained.

Alternative system embodiments can optionally also include shunt protection components to drop overvoltages, and thereby reduce the peak surge current which can be seen by the TBU.

Alternative embodiments can optionally include additional series protection components, outboard of the integrated TBU module, to provide additional protection against overvoltages.

The disclosed concepts are not intended to be limited to the specific examples and implementations disclosed herein, but are intended to include all equivalent implementations, such as (but not limited to) using different types of depletion mode devices (known or unknown at this time) or other devices to replace the example devices used to describe preferred embodiments of the present innovations. This includes, for example, changing the central TBU component in some minor way, such as by adding diodes or other devices.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. Moreover, the claims filed with this application are intended to be as comprehensive as possible: EVERY novel and non-obvious disclosed invention is intended to be covered, and NO subject matter is being intentionally abandoned, disclaimed, or dedicated.

What is claimed is:

1. A transient blocking unit comprising, in a single package having external terminals:
one or more driver devices, each connected to control current flow on at least one respective external terminal; and
at least one control die which is separate from said driver devices but also contained within said single package, and which contains control circuitry
which is connected to respective control terminals of said driver devices, to thereby implement a transient blocking operation,
and which is not directly connected to any of said external terminals.

2. The unit of claim 1, wherein said control die is thermally connected to be heat-sinked through at least one of said terminals, but said control circuitry is not electrically connected to said one terminal.

3. The unit of claim 1, wherein said control circuitry has a lower breakdown voltage than said driver devices.

4. The unit of claim 1, wherein said control circuitry includes a portion which is interposed in series between current-carrying terminals of said driver devices.

5. The unit of claim 1, wherein said control die and said driver devices are built in different respective semiconductor materials.

6. The unit of claim 1, wherein said driver devices are depletion-mode transistors.

7. The unit of claim 1, wherein said driver devices are vertical-current-flow transistors.

8. The unit of claim 1, wherein said driver devices consist of NMOS transistors.

9. A unit comprising, in a single package having external terminals:
at least one control die containing control circuitry which implements a transient blocking operation; and
one or more driver devices, each comprising a backside current-carrying terminal, a frontside current-carrying terminal, and at least one respective control terminal; said frontside current-carrying terminal being connected to said control circuitry, said control terminal also being connected to said control circuitry, and said backside current-carrying terminal being connected to ones of the external terminals;
wherein wire bonds connect said driver devices to said control die, but no wire bonds connect said devices nor said die to said external terminals.

10. The unit of claim 9, wherein said control die is thermally connected to be heat-sinked through at least one of said terminals, but said control circuitry is not electrically connected to said one terminal.

11. The unit of claim 9, wherein said control circuitry has a lower breakdown voltage than said driver devices.

12. The unit of claim 9, wherein said control circuitry includes a portion which is interposed in series between current-carrying terminals of said driver devices.

13. The unit of claim 9, wherein said control die and said driver devices are built in different respective semiconductor materials.

14. The unit of claim 9, wherein said driver devices are depletion-mode transistors.

15. The unit of claim 9, wherein said driver devices consist of NMOS transistors.

16. A unit comprising, in a single package having external terminals:
one or more vertical-current-flow driver devices, each connected to control current on at least one respective external terminal; and
at least one control die which is separate from said driver devices but also contained within said single package, and which contains control circuitry which is connected to detect electrical transients and to activate respective control terminals of said driver devices accordingly to thereby implement a transient blocking operation;
wherein wire bonds connect said driver devices to said control circuitry, but no wire bonds connect said devices nor said die to said external terminals.

17. The unit of claim 16, wherein said control die is thermally connected to be heat-sinked through at least one of said terminals, but said control circuitry is not electrically connected to said one terminal.

18. The unit of claim 16, wherein said control circuitry has a lower breakdown voltage than said driver devices.

19. The unit of claim 16, wherein said control circuitry includes a portion which is interposed in series between current-carrying terminals of said driver devices.

20. The unit of claim 16, wherein said control die and said driver devices are built in different respective semiconductor materials.

21. The unit of claim 16, wherein said driver devices are depletion-mode transistors.

22. The unit of claim 16, wherein said driver devices consist of NMOS transistors.

23. A method of blocking electrical transients, comprising the actions of:
detecting transients, using a control die which is contained in an integrated module; and
selectively blocking currents through external terminals of said device using driver dice which are incorporated in said module with said control die and which are controlled thereby;
wherein said control die contains control circuitry which is configured to perform said detection;
and wherein said control circuitry is directly connected to said driver dice within said package, but is not otherwise electrically connected to said external terminals.

24. The method of claim 23, wherein said control die is thermally connected to be heat-sinked through at least one of said terminals, but said control circuitry is not electrically connected to said one terminal.

25. The method of claim 23, wherein said control circuitry has a lower breakdown voltage than said driver devices.

26. The method of claim 23, wherein said control circuitry includes a portion which is interposed in series between current-carrying terminals of said driver devices.

27. The method of claim 23, wherein said control die and said driver devices are built in different respective semiconductor materials.

28. The method of claim 23, wherein said driver devices are depletion-mode transistors.

29. The method of claim 23, wherein said driver devices are vertical-current-flow transistors.

30. The method of claim 23, wherein said driver devices consist of NMOS transistors.

31. A method of blocking electrical transients, comprising the actions of:
detecting transients, using a control die which is contained in an integrated module; and
selectively blocking currents through external terminals of said device using driver devices which are incorporated in said module with said control die, and are controlled by said control die, but are not part of said control die;
wherein said control die is connected to said driver devices by wire bonds, but no wire bonds connect said die nor said devices to said external terminals.

32. The circuit of claim 31, wherein said control die is thermally connected to be heat-sinked through at least one of said terminals, but said control circuitry is not electrically connected to said one terminal.

33. The method of claim 31, wherein said control circuitry has a lower breakdown voltage than said driver devices.

34. The method of claim 31, wherein said control circuitry includes a portion which is interposed in series between current-carrying terminals of said driver devices.

35. The method of claim 31, wherein said control die and said driver devices are built in different respective semiconductor materials.

36. The method of claim 31, wherein said driver devices are depletion-mode transistors.

37. The method of claim 31, wherein said driver devices are vertical-current-flow transistors.

38. The method of claim 31, wherein said driver devices consist of NMOS transistors.
